(19) United States
(12) Patent Application Publication
(10) Pub. No.: US 2011/0007026 A1
(43) Pub. Date: Jan. 13, 2011

(54) POSITIONING METHOD FOR TOUCH SCREEN

(75) Inventors: PO-YANG CHEN, Miao-Li County (TW); PO-SHENG SHIH, Miao-Li County (TW); HSUAN-LIN PAN, Miao-Li County (TW)

Correspondence Address: Altis Law Group, Inc.;ATTN: Steven Reiss, 288 SOUTH MAYO AVENUE, CITY OF INDUSTRY, CA, 91789, US

(73) Assignee: CHIMEI INNOLUX CORPORATION, Miao-Li County (TW)

(21) Appl. No.: 12/821,143

(22) Filed: Jun. 23, 2010

(30) Foreign Application Priority Data
Jul. 8, 2009 (CN) 200910304151.5

(51) Int. Cl. G06F 3/045

(52) U.S. Cl. 345/174

(57) ABSTRACT

A positioning method for a touch screen including a conductive layer having an anisotropic impedance and separated detecting electrodes disposed at a side of the conductive layer is provided. A first voltage is provided to the conductive layer. A second voltage is provided to the conductive layer when the touch screen is touched, wherein a touch point is defined as where the second voltage is applied. Voltages of the detecting electrodes are sequentially measured. The relative extreme voltage and the voltage of the detecting electrode closest to the relative extreme voltage are selected. A coordinate of the touch point in the conductive layer is determined according to the relative extreme voltage and where the detecting electrode providing the voltage closest to the relative extreme voltage is.

### BACKGROUND

1. Technical Field

The disclosure is related to a positioning method of a touch screen.

2. Description of Related Art

Touch screens mainly include resistive type, capacitive type, infrared type, and surface acoustic wave type. In a four-wire or a five-wire resistive type touch screen, the variance of voltage in the conductive film is measured in an analogous method. Therefore, merely a single point can be determined at a single time point during using the touch screen. If a user operates the touch screen by simultaneously touching multi points on the touch screen, a mis-determination is caused.

A touch screen capable of simultaneously determining two or more touch points is called a multi-touch screen. A multi-touch screen is generally a multi-wire capacitive type touch screen which includes two transparent conductive layers respectively disposed at two surfaces of a transparent glass. According to the resolution of the product, each of the two conductive layers forms a plurality of patterned and parallel conductive lines. In addition, the conductive lines in two different surfaces are perpendicular to one another. The conductive lines are scanned again and again, and the variances of the capacitances by scanning the conductive lines are analyzed to determine the coordinate of a touch point.

However, the manufacturing method of the touch screen capable of simultaneously determining multi touch points is difficult and the driving method thereof is complex. Therefore, the cost of the multi-touch touch screen is increased so that the products suitable for applying the multi-touch touch screen is restricted in certain types.

### SUMMARY

For solving the problems that the manufacturing method of the touch screen is difficult, the driving method of the touch screen is complex, and the numbers of the touch points simultaneously determined is less, a positioning method of a touch screen having simple manufacturing method, driving method and capable of multi-touch operation is necessarily provided.

A positioning method for a touch screen is provided. The positioning method includes: providing a touch screen including a conductive layer having an anisotropic impedance and a plurality of separated detecting electrodes disposed at a side of the conductive layer; providing a first voltage to the conductive layer; when the touch screen is touched, providing a second voltage to the conductive layer, wherein a touch point is defined as where the second voltage is applied; sequentially measuring voltages of the detecting electrodes and selecting the relative extreme voltage and the voltage of the detecting electrode closest to the relative extreme voltage from the voltages of the detecting electrodes; and determining a coordinate of the touch point on the conductive layer according to the measured relative extreme voltage and the position of the detecting electrode providing the voltage closest to the relative extreme voltage.

In addition, a positioning method for a touch screen includes: providing a touch screen including a first conductive layer, a plurality of separated first detecting electrodes disposed at a side of the touch screen, a second conductive layer, and a plurality of separated second detecting electrodes disposed at another side perpendicular to the first detecting electrodes, wherein each of the first conductive layer and the second conductive layer has an anisotropic impedance; providing a first voltage to the first conductive layer; providing a second voltage to the second conductive layer, wherein a contact between the first conductive layer and the second conductive layer is defined as a touch point; measuring voltages of the first detecting electrodes, selecting the relative extreme voltage from the voltages of the first detecting electrodes and the voltage of the first detecting electrode closest to the relative extreme voltage from the voltages of the first detecting electrodes, and determining a horizontal coordinate of the touch point according to the relative extreme voltage from the voltages of the first detecting electrodes and the position of the first detecting electrode providing the voltage closest to the relative extreme voltage from the voltages of the first detecting electrodes; and measuring voltages of the second detecting electrodes, selecting the relative extreme voltage from the voltages of the second detecting electrodes and the voltage of the second detecting electrode closest to the relative extreme voltage from the voltages of the second detecting electrodes, and determining a vertical coordinate of the touch point according to the relative extreme voltage from the voltages of the second detecting electrodes and the position of the second detecting electrode providing the voltage closest to the relative extreme voltage from the voltages of the second detecting electrodes.

Compared with the conventional technology, the touch screen applying the abovementioned positioning method uses a material having an anisotropic impedance, particularly uses a conductive polymer material or a carbon nanotube material, and more particularly uses the carbon nanotube film having a preferred orientation arrangement to fabricate the conductive layer so that the positioning method has the following advantages: the first, the resistivity of the carbon nanotube film having the preferred orientation arrangement has an anisotropic characteristic so that the real coordinate of the touch point can be determined according to the position where the voltage is reduced and the reducing magnitude of the voltage through measuring the voltages of the sides of the carbon nanotube film. Therefore, the touch screen has simple physical structure and simple driving method. The second, the carbon nanotube film are divided into a plurality of conductive channels extending along the extending direction of the carbon nanotubes. Different detecting electrodes are disposed respectively corresponding to different conductive channels so that the touch screen accomplishes multi-touch operation according to the voltage variance in each conductive channel. In addition, in theory, the numbers of the touch points are not restricted so as to truly achieve the multi-touch function. The third, the superior mechanical property of the carbon nanotubes renders the carbon nanotube film have high tenacity and mechanical strength. Therefore, it is conducive to improve the durability of the touch screen by using the carbon nanotube film as the conductive layer. The fourth, the carbon nanotube film has desirable conductivity so as to enhance the conductive property of the touch screen and further enhance the resolution and the accuracy thereof. The fifth, the carbon nanotube film has good transparency of light so that the touch screen has desirable optical property.

In the aforesaid touch screen, a positioning method of the touch screen called three-points interpolation algorithm is provided by using the three voltages obtained through measuring the voltage variances of the detecting electrodes and selecting the relative extreme voltage and the voltages closest to the relative extreme voltage, which is capable of accurately determining the coordinate of any point on the touch screen and has high precision.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic cross-sectional structure of a touch screen according to a first embodiment of the disclosure.

FIG. 2 is a schematic plane structure of the first transmitting layer and the second transmitting layer in the touch screen illustrated in FIG. 1.

FIG. 3 is the voltage curve diagram of the detecting electrodes in the touch screen illustrated in FIG. 1 when the touch screen is not touched.

FIG. 4 is a schematic diagram showing the real position of the touch points when a three points operation is performed on the touch screen illustrated in FIG. 1.

FIG. 5 is the voltage curve diagram of the detecting electrodes in the touch screen illustrated in FIG. 4 when the three points operation is performed.

FIG. 6 is a schematic plane structure of the first transmitting layer and the second transmitting layer in a touch screen according to a second embodiment of the disclosure.

FIG. 7 is a schematic diagram showing the measured voltages according to a first example when the touch screen illustrated in FIG. 6 applies a three-points interpolation algorithm to determine the touch point.

FIG. 8 is a schematic diagram showing the measured voltages according to a second example when the touch screen illustrated in FIG. 6 applies a three-points interpolation algorithm to determine the touch point.

FIG. 9 is a schematic diagram which shows the regions of the touch screen illustrated in FIG. 6 when the touch screen is divided into several regions for determining the coordinates of the touch points.

### DETAILED DESCRIPTION

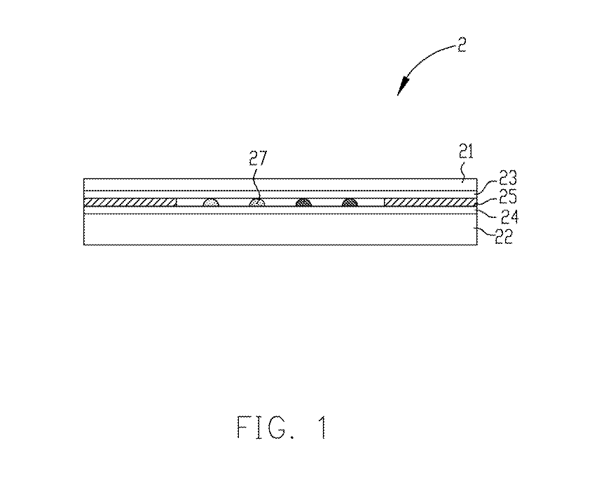

FIG. 1 is a schematic cross-sectional structure of a touch screen 2 according to a first embodiment of the disclosure. The touch screen 2 includes a first substrate 21 and a second substrate 22 disposed opposite to each other. The first substrate 21 is generally fabricated by an elastic material, and the second substrate 22 is made by a rigid material to sustain certain pressure. In the present embodiment, the first substrate 21 is a polyester film, and the second substrate 22 is a glass substrate. A first transmitting layer 23 is disposed at a surface of the first substrate 21 opposite to the second substrate 22. A second transmitting layer 24 is disposed at a surface of the second substrate 22 opposite to the first substrate 21. An adhesion layer 25 is disposed at the margin between the first substrate 21 and the second substrate 22 so that the first substrate 21 and the second substrate 22 are adhered together. A distance between the first transmitting layer 23 and the second transmitting layer 24 can range from 2 μm to 10 μm, in one embodiment, for example. A plurality of spacers 27 separated from one another are disposed between the first transmitting layer 23 and the second transmitting layer 24 for support and to electrically insulate the first transmitting layer 23 and the second transmitting layer 24 from each other at an initial state. It is understood that when the touch screen 2 is designed in a small size, only if the first transmitting layer 23 and the second transmitting layer 23 are surely electrically insulated from each other in the initial state can the spacers 27 be selectively disposed in the touch screen 2.

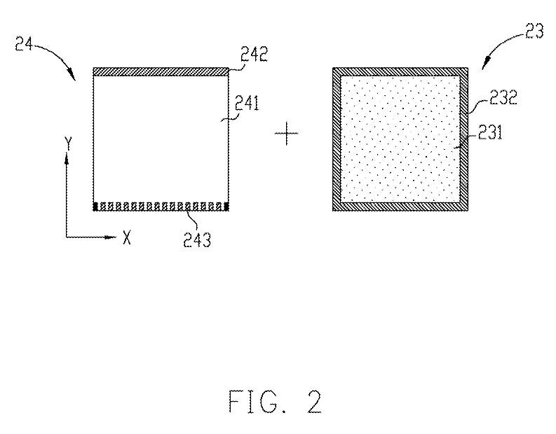

FIG. 2 is a schematic plane structure of the first transmitting layer 23 and the second transmitting layer 24. In FIG. 2, a Cartesian coordinate system including an X axis direction and a Y axis direction perpendicular to each other is introduced. The first transmitting layer 23 includes a first conductive layer 231 and a first electrodes 232. The first conductive layer 231 is a rectangular indium tin oxide thin film so as to have low resistivity and high light transparency. The first electrode 232 is continuously disposed at the four edges of the first conductive layer 231 and electrically connected to the first conductive layer 231.

The second transmitting layer 24 includes a second conductive layer 241, a second electrode 242, and a plurality of detecting electrodes E₁₁ to E₁ₓ, where x is a natural number which represents the numbers of the detecting electrodes 243.

The second conductive layer 241 is a conductive film having an anisotropic impedance, i.e. the resistivity thereof is various in 2-dimensional space. Specifically, the lateral resistivity ρ1 of the second conductive layer 241 along the X axis direction is larger that the longitudinal resistivity ρ2 of the second conductive layer 241 along the Y axis direction.

The second electrode 242 is a stripe-like electrode which is disposed at a side of the second transparent conductive layer 241 perpendicular to the extending direction of the carbon nanotubes, i.e. the upper side of the second transparent conductive layer 241 in FIG. 2, and electrically connected to the second transparent conductive layer 241.

The detecting electrodes E₁₁ to E₁ₓ are evenly arranged at another side of the second conductive layer 241 opposite to the second electrode 242, i.e. the bottom side of the second transparent conductive layer 241 in FIG. 2, and are all electrically connected to the second conductive layer 241. Because of the anisotropic impedance of the carbon nanotube thin film, the detecting electrodes E₁₁ to E₁ₓ divides the second conductive layer 241 into a plurality of corresponding conducting channels.

In an embodiment, the second conductive layer 241 is fabricated by carbon nanotube thin film material with even thickness. A thickness of the carbon nanotube thin film can range from 0.5 nm to 100 nm, in one embodiment, for example. The carbon nanotube thin film is a layer structure with even thickness formed by orderly arranged carbon nanotubes. The carbon nanotubes are one or more combination of signal wall carbon nanotubes, dual wall carbon nanotubes, and multi wall carbon nanotubes, where a diameter of the signal wall carbon nanotubes is 0.5 nm to 50 nm, a diameter of the dual wall carbon nanotubes is 1.0 nm to 50 nm, and a diameter of the multi wall carbon nanotubes is 1.5 nm to 50 nm. The carbon nanotubes in the carbon nanotube thin film are arranged in a single preferred orientation or in a plurality of preferred orientations.

Furthermore, the second conductive layer 241 is made of one carbon nanotube thin film or overlapping carbon nanotube thin films, and the overlapping angle of the overlapping carbon nanotube thin films is not restricted here. The carbon nanotubes are orderly arranged. Moreover, the carbon nanotube thin film includes a plurality of carbon nanotubes arranged in a preferred orientation. The carbon nanotubes have substantially equivalent lengths so as to connect together through van der Waals force to form continuous carbon nanotube beams. Specifically, the carbon nanotubes in the second conductive layer 241 are arranged in a preferred orientation of the Y axis direction illustrated in FIG. 2.

The aforesaid carbon nanotubes thin film having preferred orientation arrangement has a characteristic of anisotropic impedance, i.e. the resistivity of the carbon nanotube film in the extending direction of the carbon nanotubes is much smaller than the resistivity of the carbon nanotube film in the direction perpendicular to the extending direction of the carbon nanotubes. Specifically, the lateral resistivity of the second conductive layer 241 in the X axis direction is much larger that the longitudinal resistivity of the second conductive layer 241 in the Y axis direction.

Generally, the value of ρ1/ρ2 ratio is increased along with the increasing of the size of the touch screen 2. When the size of the touch screen 2 (the diagonal of the rectangle) is smaller than 3.5 inch, the value of ρ1/ρ2 ratio is, preferredly, not smaller than 2. When the size of the touch screen 2 (the diagonal of the rectangle) is larger than 3.5 inch, the value of ρ1/ρ2 ratio is, preferredly, not smaller than 5.

Furthermore, the size of the touch screen 2 is 3.5 inch in the present embodiment and the ρ1/ρ2 ratio which represents a ratio of the lateral resistivity to the longitude resistivity of the applied carbon nanotubes is larger than and equal to 100. For example, the lateral resistivity can be 540 kΩ and the longitudinal resistivity can be 3.6 kΩ.

The first electrode 232, the second electrode 242 and the detecting electrodes E₁₁ to E₁ₓ are formed by materials having low impedance, such as Al, Cu, Ag, for example, so as to reduce the attenuation of the electronic signal. In the present embodiment, they can all be made of conductive silver paste.

The driving method of the touch screen 2 is shown as follows.

During the driving method, the first electrode 232 is connected to a first voltage, and the second electrode 242 and the detecting electrodes E₁₁ to E₁ₓ are connected to a second voltage, wherein the first voltage can be higher than the second voltage and may be lower than the second voltage. The following positioning method is provided by taking an example in which the first voltage is lower than the second voltage. Specifically, the first electrode 232 is electrically connected to a ground of the touch screen system 2, i.e. the voltage of the first conductive layer 231 is zero V. The second electrode and the detecting electrodes E₁₁ to E₁ₓ are applied by a high voltage, such as 5V in the present embodiment, so that the voltage of the second conductive layer 241 is 5V. The detecting electrodes E₁₁ to E₁ₓ are used to detect the voltage variance of the second conductive layer 241 corresponding to different positions so as to provide a reference data to the positioning method.

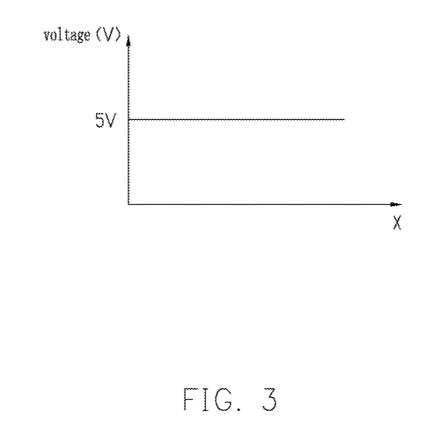

When the user does not perform any operation on the touch screen 2, the first conductive layer 231 and the second conductive layer 241 are electrically insulated from each other so that the voltage of the second conductive layer 241 is not influenced. Accordingly, the measured voltages of the detecting electrodes E₁₁ to E₁ₓ are equivalent, such as 5V. FIG. 3 being the voltage curve diagram of the detecting electrodes E₁₁-E₁ₓ in the touch screen illustrated in FIG. 1 when the touch screen is not touched is further referred to. The horizontal axis shows physical coordinates of the detecting electrodes E₁₁-E₁ₓ and the vertical axis shows the measured voltages of the detecting electrodes E₁₁-E₁ₓ in FIG. 3. Owing to the equivalence of the measured voltages of the detecting electrodes E₁₁-E₁ₓ a straight line perpendicular to the vertical axis is shown in the drawing figure.

When the user performs an operation on the touch screen 2, the first substrate 21 is curved toward the second substrate 22 under the pressure of the operation so that the first conductive layer 231 and the second conductive layer 241 are electrically connected at the touch point. If a single point is touched, a single connecting point is generated at the touch point. If multi points are touched, a plurality of connecting points are correspondingly generated. The measured voltage of one of the detecting electrodes E₁₁-E₁ₓ corresponding to the touch point is changed because the voltage of the first conductive layer 231 is lower than the voltage of the second conductive layer 241. Specifically, the voltage of the corresponding one of the detecting electrodes E₁₁-E₁ₓ is lower than the voltage of the second electrodes 241, i.e. smaller than 5V. According to an experiment, the reducing magnitude of the voltage of the corresponding detecting electrode is related to the vertical coordinate of the touch point. The closer the touch point to the second electrode 242 is, the smaller the reducing magnitude of the voltage of the detecting electrode corresponding to the touch point is. On the contrary, the farther the touch point to the second electrode 242 is, the larger the reducing magnitude of the voltage of the detecting electrode corresponding to the touch point is, that is, the voltage of the detecting electrode corresponding to the touch point is positively related to the distance from the touch point to the second electrode 242.

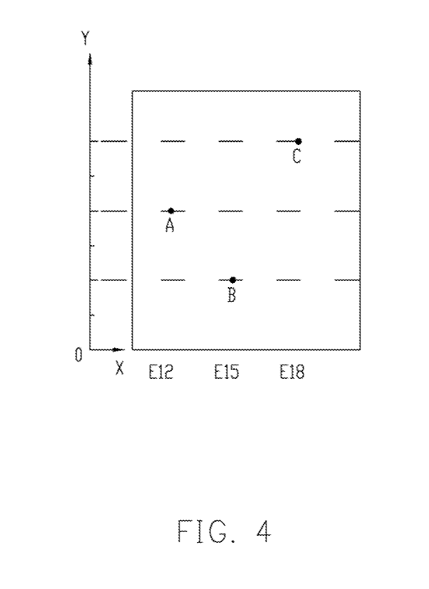

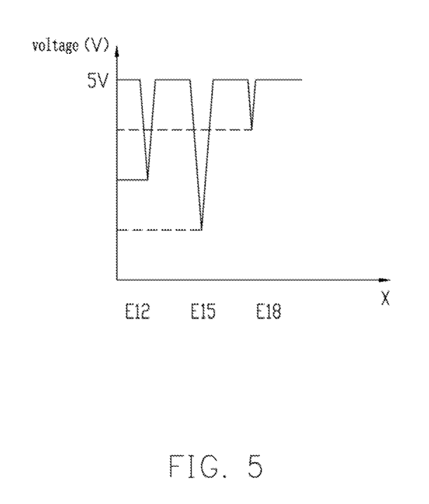

FIG. 4 and FIG. 5 are simultaneously referred to, wherein FIG. 4 is a schematic diagram showing the coordinates of the touch points in a three points operation performed on the touch screen illustrated in FIG. 1 and FIG. 5 is the voltage curve diagram of the detecting electrodes in the touch screen illustrated in FIG. 4 when the three points operation is performed. The real positions of three touch points A, B, C simultaneously performed on the touch screen 2 is shown in FIG. 4, and the positions of the detecting electrodes E12, E15, E18 are respectively corresponding to the three touch points A, B, C. The horizontal axis shows the horizontal coordinates of the detecting electrodes E₁₁-E₁ₓ and the vertical axis shows the measured voltages of the detecting electrodes E₁₁-E₁ₓ in FIG. 5. As shown in the figures, the voltages of the three detecting electrodes E12, E15, and E18 have various reducing magnitudes, respectively.

Based on the positions of the reduced voltages in the voltage curve in the coordinate, the detecting electrodes E12, E15, and E18 can be directly served as the detecting electrodes corresponding to the three touch points A, B, and C. The horizontal coordinates of the detecting electrodes E12, E15, and E18 can thus be considered as the horizontal coordinates of the three touch points. Furthermore, based on the reducing magnitudes of the voltages of the three detecting electrodes E12, E15, and E18, the distances from the three touch points to the detecting electrodes E₁₁-E₁ₓ can be analyzed so as to obtain the vertical coordinates of the touch points. By the above method, the coordinates of all touch points on the touch screen can be determined.

The touch screen 2 applying the carbon nanotube film has the following advantages: the first, the resistivity of the carbon nanotube film having the preferred orientation arrangement has an anisotropic characteristic so that the coordinate of the touch point can be determined through measuring the voltages of the detecting electrodes E11-E1x and referring to the location where the voltage is reduced and the magnitude how the voltage is reduced. Therefore, the touch screen 2 has simple physical structure and simple driving method. The second, the carbon nanotube film are divided into a plurality of conductive channels extending along the extending direction of the carbon nanotubes. Different detecting electrodes E1-Ex are corresponding to different conductive channels so that the touch screen 2 accomplishes multi-touch operation. In addition, in theory, the numbers of the touch points are not restricted so as to truly achieve the multi-touch function. The third, the superior mechanical property of the carbon nanotube renders the carbon nanotube layer have high tenacity and mechanical strength. Therefore, it is conducive to improve the durability of the touch screen 2 by using the carbon nanotube layer as the conductive layer. The fourth, the carbon nanotube film has desirable conductivity so as to enhance the conductive property of the touch screen and further enhance the resolution and the accuracy thereof. The fifth, the carbon nanotube film has good transparency of light so that the touch screen has desirable optical property.

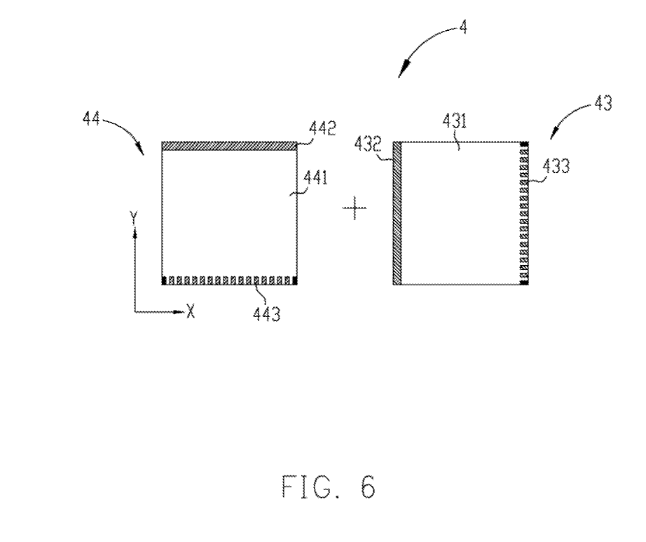

FIG. 6 is a schematic plane structure of the first transmitting layer 43 and the second transmitting layer 44 according to a second embodiment of the disclosure. The drawing figure merely shows the plane structures of a first transmitting layer 43 and a second transmitting layer 44. The touch screen 4 is similar to the touch screen 2 of the first embodiment, and the difference lies in that the structure of the first transmitting layer 43 is similar to the second transmitting layer 44. The first transmitting layer 43 includes a first conductive layer 431 made of a carbon nanotube thin film, a stripe-like first electrode 432, and a plurality of first detecting electrodes E₂₁-E_{2y}, where y is a natural number representing the numbers of the first detecting electrodes. The second transmitting layer 44 includes a second conductive layer 441 made of a carbon nanotube thin film, a stripe-like second electrode 442, and a plurality of second detecting electrodes E₁₁ to E₁ₓ, where x is a natural number which represents the numbers of the second detecting electrodes. In addition, the carbon nanotubes in the first conductive layer 431 are extended along the X axis direction of the coordinate. The first electrode 432 is disposed at the left side of the first transparent conductive layer 431, extended along the Y axis direction, and electrically connected to the first transparent conductive layer 431. The first detecting electrodes E21-E2y are evenly arranged at the right side of the first conductive layer 431 opposite to the first electrode 432 and electrically connected to the first conductive layer 431. The resistivity ρ3 of the first conductive layer 431 in the Y axis direction is larger than the resistivity ρ4 of the first conductive layer 431 in the X axis direction, and the value of ρ3/ρ4 ratio is increased along with the increasing of the size of the first conductive layer 431 in the Y axis direction.

The driving method of the touch screen 4 includes the following steps. The first electrode 432 and the first detecting electrodes E₂₁-E_{2y} are connected to a ground voltage, and the second electrode 442 and the second detecting electrodes E₁₁-E₁ₓ are connected to a high voltage such as 5V in the present embodiment when measuring the horizontal coordinate of the touch point. The horizontal coordinate of the touch point is determined by respectively measuring the voltages of the second detecting electrodes E₁₁-E₁ₓ. The voltages of the first detecting electrodes E₂₁-E_{2y} are respectively measured to determine the vertical coordinate of the touch point when measuring the vertical coordinate of the touch point.

In the positioning method for the touch screen 4, the horizontal coordinate and the vertical coordinate of the touch point are determined by applying a low voltage to the first electrode 432 and the first detecting electrodes E₂₁-E_{2y}, applying a high voltage to the second electrode 442 and the second detecting electrodes E₁₁-E₁ₓ and respectively measuring the voltage variances of the first detecting electrodes E₂₁-E_{2y} and the second detecting electrodes E₁₁-E₁ₓ. Therefore, the reducing magnitude of the voltage is not required to be analyzed. The driving method is more simple and accurate.

Further, in addition to using the carbon nanotube film to serve as the conductive layer in the above embodiment, other material having an anisotropic impedance, such as conductive polymer materials, certain crystalline materials having low dimensional characteristics (one dimension or two dimensions) can also be used to form the conductive layer. In the above mentioned crystalline materials having low dimensional characteristics (one dimension or two dimensions), the electrons of the material are restricted to conduct in a one-dimensional linearity or in a two-dimension plane. Therefore, the conductivity of the crystalline materials is superior in one or two specific lattice direction and significantly reduced in other directions so that the crystalline material has an anisotropic impedance that is also called an anisotropy of conductivity. These materials comply with the requirement of the conductive layer having anisotropy of conductivity in the disclosure and facilitates the same or similar effect mentioned in the above embodiments.

Nevertheless, the above driving method is used to accurately determine the coordinate of the touch point when the touch point is right located at the horizontal line where any of the first detecting electrode E₂₁-E_{2y} is located, or the vertical line where any of the second detecting electrode E₁₁-E₁ₓ is located. When the touch point is located at the midpoint between any two of the first detecting electrodes E₂₁-E_{2y} or the midpoint between any two of second detecting electrodes E₁₁-E₁ₓ the accurate position of the touch point is obtained by calculating the known measured voltages in an interpolation algorithm.

A calculating method called three-points interpolation algorithm is detailed introduced in the following. The calculating method can be used to accurately determine the coordinate of any point in the touch screen 4, and herein the positioning method of the horizontal coordinate of the calculating method is detailed depicted as an example.

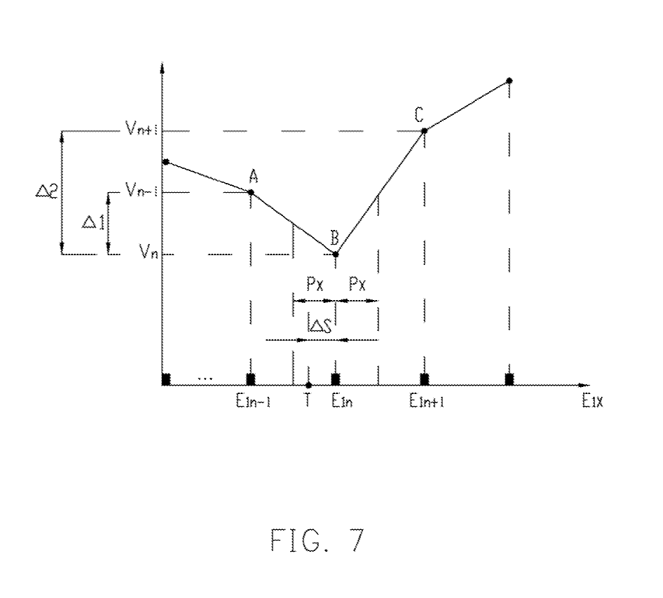

FIG. 7 is a schematic diagram showing the measured voltages according to a first example when a three-points interpolation algorithm is used to determine the touch point. The horizontal axis shows the second detecting electrodes E₁₁-E₁ₓ and the horizontal coordinates thereof in FIG. 7. The vertical axis shows the output voltages of the second detecting electrodes E₁₁-E₁ₓ in FIG. 7. For clearly showing the voltage variance of the touch point, only the measured voltages of the touch point and the neighbor points close to the touch point are illustrated in the drawing figure. The point T is the relative position of the touch point in the horizontal axis of the touch screen 4. The point B is the minimum voltage in the measured voltage curve diagram, Xn is the horizontal coordinate of the second detecting electrode E₁ₙ providing the minimum voltage, and 2≦n≦x−1. The point A and the point C are the measured voltages corresponding to the second detecting electrodes E₁ₙ₋₁ and E₁ₙ₊₁ closest to the second detecting electrode E₁ₙ providing the minimum voltage in the left side and the right side. The voltages of the points A, B, and C are respectively Vₙ₋₁, Vₙ, and Vₙ₊₁, where Vₙ₋₁≧Vₙ and Vₙ₊₁≧Vₙ.

A normal value Px and a variable ΔS are configured, where the value of Px is a half of the distance of any adjacent two of the second detecting electrodes E₁₁-E₁ₓ, and the value of ΔS is equal to the lateral distance from the touch point T to the closest second detecting electrode E₁ₙ. The relationships of ΔS to Vₙ₋₁, Vₙ, and Vₙ₊₁ satisfy the following set of equations.

$$Δ S = f ( Δ 1 , Δ 2 ) \\ Δ 1 = \vert {V}_{n - 1} - {V}_{n} \vert \\ Δ 2 = \vert {V}_{n + 1} - {V}_{n} \vert \qquad ( 1 )$$

Furthermore, the set of equations 1 can be specifically shown as:

$$\begin{matrix}\{ \begin{matrix}Δ 1 > Δ2 ⇒ Δ S = {P}_{x} \times \frac{Δ 1 - Δ 2}{Δ 1} \\ Δ 1 = Δ 2 ⇒ Δ S = 0 \\ Δ 1 < Δ 2 ⇒ Δ S = {P}_{x} \times \frac{Δ 1 - Δ 2}{Δ 2}\end{matrix} & ( 2 ) \\ and Xt = Xn + Δ S & ( 3 )\end{matrix}$$

where Xt is the horizontal coordinate of the touch point, the position Xt of touch point is a function taking any two of (Vₙ₋₁−Vₙ₊₁), (Vₙ₊₁−Vₙ), and (Vₙ₋₁−Vₙ) as the variables when the Vn is the minimum voltage. Xn is the horizontal coordinate of the second detecting electrode E₁ₙ.

Therefore, the following set of equations is obtained by combining the sets of equations (1), (2), and (3):

$$\{ \begin{matrix}{V}_{n - 1} < {V}_{n + 1} ⇒ Xt = Xn + {P}_{x} \times \frac{{V}_{n - 1} - {V}_{n + 1}}{{V}_{n + 1} - {V}_{n}} \\ {V}_{n - 1} = {V}_{n + 1} ⇒ Xt = Xn \\ {V}_{n - 1} > {V}_{n + 1} ⇒ Xt = Xn + {P}_{x} \times \frac{{V}_{n - 1} - {V}_{n + 1}}{{V}_{n - 1} - {V}_{n}}\end{matrix} \qquad ( 4 )$$

The calculation method of the three particular points are described in the following.

### When Δ1≈0; Δ2≠0, ΔS≈−Pₓ and Xt≈Xn−Pₓ.

That means that the touch point is close to the midline between the second detecting electrode E₁ₙ₋₁ and the second detecting electrode E₁ₙ and the horizontal coordinate thereof is close to Xn-Px.

### When Δ1=Δ2, ΔS=0 and Xt≈Xn.

Thus, the touch point is close to the position corresponding to the detecting electrode En, and the horizontal coordinate thereof is close to Xn.

### When Δ1≠0; Δ2≈0, ΔS=+Pₓ and Xt≈Xn+Pₓ.

That means that the touch point is close to the midline between the second detecting electrode E₁ₙ and the second detecting electrode E₁ₙ₊₁, and the horizontal coordinate thereof is close to Xn+Px.

The above three conditions satisfy the experimental analog calculation, which shows that the set of equations (2) satisfies description of the position of the touch point T. Therefore, the position of any point in the horizontal axis of the touch screen 4 can be precisely positioned by using the above set of equations (4).

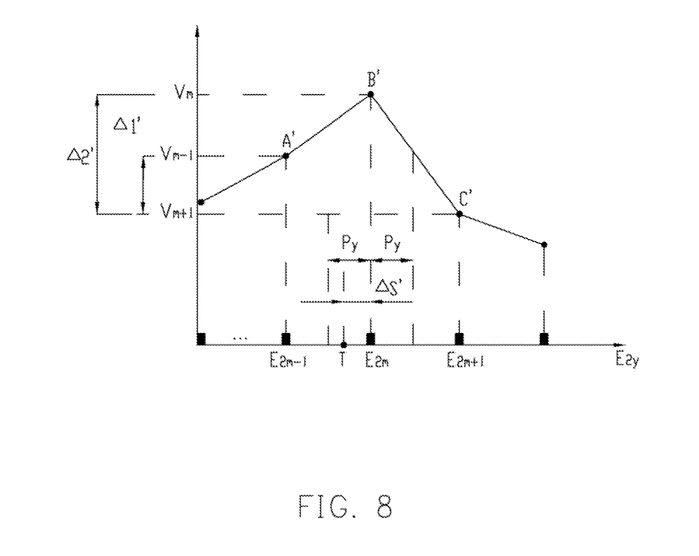

FIG. 8 is a schematic diagram showing the measured voltages according to a second example when the touch screen applies a three-points interpolation algorithm to determine the touch point. Base on the same principle, the voltage at the touch point measured by the first detecting electrodes E₂₁˜E_{2y} is the maximum voltage in the present example, and the drawing figure only shows the measured voltage of the touch point for clearly directing to the voltage variation of the touch point. The point T is the relative position of the touch point in the vertical axis of the touch screen 4. The point B′ is the maximum voltage in the measured voltage curve which is corresponding to the first detecting electrode E₂ₘ, and 2≦m≦y−1. The point A′ and the point C′ are the measured voltages corresponding to the first detecting electrodes E₂ₘ₋₁ and E₂ₘ₊₁ most adjacent to the first detecting electrode E₂ₘ providing the maximum voltage in the left side and the right side. The voltages of the points A, B, and C are respectively Vₘ₋₁′,Vₘ′, and Vₘ₊₁, where Vₘ₋₁′≧Vₘ′ and Vₘ₊₁′≧Vₘ′.

A normal value Py and a variable ΔS′ are configured, where the value of Py is a half of the distance of any adjacent two of the first detecting electrodes E₂₁-E_{2y} and the value of ΔS′ is equal to the lateral distance from the touch point T to the closest first detecting electrode E₂ₘ. The relationships of ΔS′ to Vₘ₋₁′, Vₘ′, and Vₘ₊₁′ satisfy the following set of equations.

$$Δ {S}^{′} = f ( Δ {1}^{′} , Δ {2}^{′} ) \\ Δ {1}^{′} = \vert {V}_{m - 1}^{{ }^{′}} - {V}_{m}^{{ }^{′}} \vert \\ Δ {2}^{′} = \vert {V}_{m + 1}^{′} - {V}_{m}^{′} \vert \qquad ( 5 )$$

Furthermore, the set of equations 5 can be specifically shown as:

$$\begin{matrix}\{ \begin{matrix}Δ {1}^{′} > {Δ2}^{′} ⇒ Δ {S}^{′} = Py \times \frac{Δ {1}^{′} - Δ {2}^{′}}{Δ 1} \\ Δ {1}^{′} = Δ {2}^{′} ⇒ Δ {S}^{′} = 0 \\ Δ {1}^{′} < Δ {2}^{′} ⇒ Δ {S}^{′} = Py \times \frac{Δ {1}^{′} - Δ {2}^{′}}{Δ {2}^{′}}\end{matrix} & ( 6 ) \\ and Yt = Ym + Δ {S}^{′} & ( 7 )\end{matrix}$$

where Yt is the vertical coordinate of the touch point, when the Vm is the maximum voltage, the position Yt of touch point is a function taking any two of (Vₘ₋₁−Vₘ₊₁), (Vₘ₊₁−Vₘ), and (Vₘ₋₁−Vₘ) as variables. Ym is the vertical coordinate of the first detecting electrode E₂ₘ.

Therefore, the following set of equations is obtained by combining the sets of equations (5), (6), and (7):

$$\{ \begin{matrix}{V}_{m - 1} < {V}_{m + 1} ⇒ Yt = Ym + {P}_{y} \times \frac{{V}_{m - 1} - {V}_{m + 1}}{{V}_{m + 1} - {V}_{m}} \\ {V}_{m - 1} = {V}_{m + 1} ⇒ Yt = Ym \\ {V}_{m - 1} > {V}_{m + 1} ⇒ Yt = Ym + {P}_{y} \times \frac{{V}_{m - 1} - {V}_{m + 1}}{{V}_{m - 1} - {V}_{m}}\end{matrix} \qquad ( 8 )$$

The calculation method of three particular points are described in the following.

### When Δ1′≈0; Δ2′≠0, ΔS′≈−P_{y} and Yt≈Ym−P_{y}.

That means that the touch point is close to the midline between the first detecting electrode E₂ₘ₋₁ and the first detecting electrode E₂ₘ, and the vertical coordinate thereof is close to Ym−Py.

### When Δ1′=Δ2′, ΔS″=0 and Yt≈Ym.

Thus, the touch point is close to the position corresponding to the first detecting electrode E₂ₘ, and the vertical coordinate thereof is close to Yₘ.

### When Δ1′≠0; Δ2′≈0, ΔS′≈+P_{y} and Yt≈Ym+P_{y}.

That means that the touch point is close to the midline between the first detecting electrode E₂ₘ and the first detecting electrode E₂ₘ₊₁, and the vertical coordinate thereof is close to Ym+Py.

The above three conditions satisfy the experimental analog calculation, which shows that set of the equations (6) satisfies description of the position of the touch point T. Therefore, the position of any point in the vertical axis of the touch screen 4 can be precisely positioned by using the above set of equations (8).

The position of any point in the touch screen can be further accurately positioned by using the abovementioned algorithm.

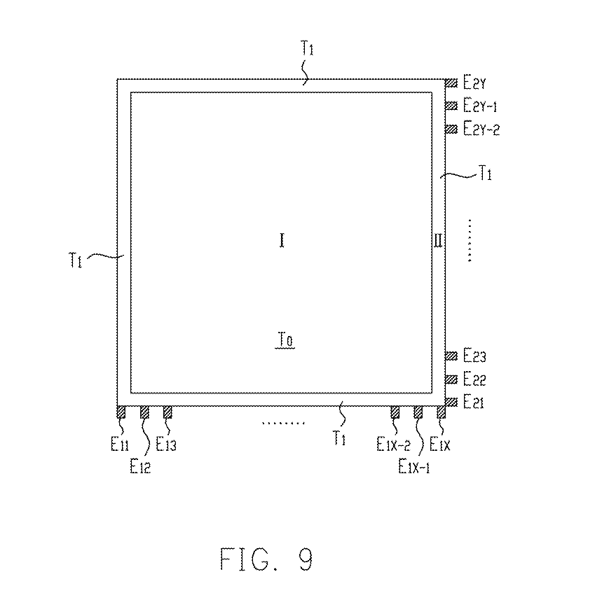

FIG. 9 is a schematic diagram which shows the regions of the touch screen when the touch screen is divided into several regions for determining the positions of the touch points. The touch screen 4 is divided into two regions which are respectively the middle region I and the periphery region II, wherein the middle region I includes the regions separated from the horizontal edges by a distance larger than or equal to Py and separated from the vertical edges by a distance larger than or equal to Px. The periphery region II includes all the regions separated from the horizontal edges by a distance smaller than Py and separated from the vertical edges by a distance smaller than Px. Herein, the values of Px and Py are referred to the aforesaid definition.

When the touch point such as the touch point T0 is located at the middle region I, the position of the touch point can be positioned by using the above-mentioned equations (4) and (8).

When the touch point is located at the periphery region II, the coordinate of the touch point satisfies the following equations.

The measured relative extreme voltage from the voltages of the second detecting electrodes is the minimum voltage and the measured relative extreme voltage from the voltages of the first detecting electrodes is the maximum voltage when the first voltage is higher than the second voltage.

If the touch point T₁ is located between E₁₁ and E₁₁+Pₓ, the detecting electrode E₁₁ is closest to the touch point and only the detecting electrode E₁₂ is the second closet to the touch point in the horizontal axis direction.

In respect of the horizontal coordinate:

The position Xt of the touch point is a function taking as a variable when V₁ is the minimum voltage, and the position Xt of the touch point satisfies the following equations:

$$Xt = X 1 + {P}_{x} - {P}_{x} \times \frac{{V}_{2} - {V}_{1}}{{V}_{R} - {V}_{1}} ,$$

V_{R} is a reference voltage, where V_{R}>V₂>V₁.

If the touch point T₁ is located between E₁ₓ and E₁ₓ−Pₓ, the detecting electrode E₁ₓ is closest to the touch point and only the detecting electrode E₁ₓ₋₁ is the second closet to the touch point in the horizontal axis direction. Herein, the position Xt of the touch point is a function taking (Vₓ₋₁−V_{X}) as a variable when Vₓ is the minimum voltage, and the coordinate of the touch point satisfies the following equations:

$$Xt = Xx - {P}_{x} + {P}_{x} \times \frac{{V}_{x - 1} - {V}_{x}}{{V}_{R} - {V}_{x}} ,$$

V_{R} is a reference voltage, where V_{R}>Vₓ₋₁>Vₓ₋₁>Vₓ.

The coordinate Yₜ satisfies the abovementioned set of equations (8).

If the touch point T₁ is located between E₂₁ and E₂₁+P_{y}, the detecting electrode E₂₁ is closest to the touch point and only the detecting electrode E₂₂ is the second closet to the touch point in the vertical axis direction.

In respect of the vertical coordinate:

The position Yt of the touch point is a function taking (V₁′−V₂′) as a variable when V₁ is the maximum voltage, and the position Yt of the touch point satisfies the following equations:

$$Yt = {Y}_{1} + {P}_{y} - {P}_{y} \times \frac{{V}_{1}^{′} - {V}_{2}^{′}}{{V}_{1}^{′} - {V}_{R}^{′}} ,$$

V_{R}′ is a reference voltage, where V₁′>V₂′>V_{R}′.

If the touch point T₁ is located between E_{2y} and E_{2y}−P_{y}, the detecting electrode E_{2y} is closest to the touch point and only the detecting electrode E_{2y-1} is the second closet to the touch point in the vertical axis direction. Herein, the position Yt of the touch point is a function taking (V_{y}′−V_{y-1}′) as a variable when V_{y}′ is the maximum voltage, and the coordinate of the touch point satisfies the following equations:

$$Yt = Yy - {P}_{y} + {P}_{y} \times \frac{{V}_{y}^{′} - {V}_{y - 1}^{′}}{{V}_{y}^{′} - {V}_{R}^{′}} ,$$

V_{R}′ a reference voltage, where V_{y}′>V_{y-1}′>V_{R}′.

The coordinate Xt satisfies the abovementioned set of equations (4).

What is claimed is:

1. A positioning method for a touch screen, comprising:
providing the touch screen comprising a conductive layer having anisotropic impedance and a plurality of separated detecting electrodes disposed at a side of the conductive layer;
providing a first voltage to the conductive layer;
providing a second voltage to the conductive layer when the touch screen is touched, wherein a touch point is defined as where the second voltage is applied;
measuring voltages of the detecting electrodes and selecting the relative extreme voltage and the voltage of the detecting electrode closest to the relative extreme voltage from the voltages of the detecting electrodes; and
determining a coordinate of the touch point on the conductive layer based on the relative extreme voltage and the position of the detecting electrode providing the voltage closest to the relative extreme voltage.

2. The positioning method of claim 1, wherein the detecting electrodes are defined as E₁₁ to E₁ₓ, the voltages respectively corresponding to the detecting electrodes are defined as V₁ to V_{X}, coordinates of the detecting electrodes are defined as X₁ to Xₓ, a distance between any adjacent two of the detecting electrodes is defined as 2Px, a middle electrode is defined as E₁ₙ, 2≦n≦x−1, Vₙ is the relative extreme voltage, the two detecting electrodes closest to the detecting electrode providing the relative extreme voltage are defined as E₁ₙ₋₁ and E₁ₙ₊₁, and the coordinate of the touch point is Xt.

3. The positioning method of claim 2, wherein the relative extreme voltage is a maximum voltage when the first voltage is lower than the second voltage.

4. The positioning method of claim 3, wherein the coordinate Xt of the touch point satisfies an equation when V₁ is the maximum voltage:
$$Xt = {X}_{1} + {P}_{x} - {P}_{x} \times \frac{{V}_{1} - {V}_{2}}{{V}_{1} - {V}_{R}} ,$$
Y_{R} is a reference voltage, where V₁>V₂>V_{R}.

5. The positioning method of claim 3, wherein the coordinate Xt of the touch point satisfies an equation when Vₓ is the maximum voltage:
$${X}_{t} = Xx - {P}_{x} + {P}_{x} \times \frac{{V}_{x} - {V}_{x - 1}}{{V}_{x} - {V}_{R}} ,$$
Y_{R} is a reference voltage, where Vₓ>Vₓ₋₁>V_{R}.

6. The positioning method of claim 3, wherein the coordinate Xt of the touch point satisfies a set of equations when Vₙ is the maximum voltage and 2<n<x−1:
$$\{ \begin{matrix}{V}_{n - 1} < {V}_{n + 1} ⇒ Xt = Xn + {P}_{x} \times \frac{{V}_{n + 1} - {V}_{n - 1}}{{V}_{n} - {V}_{n - 1}} \\ {V}_{n - 1} = {V}_{n + 1} ⇒ Xt = Xn \\ {V}_{n - 1} > {V}_{n + 1} ⇒ Xt = Xn + {P}_{x} \times \frac{{V}_{n + 1} - {V}_{n - 1}}{{V}_{n} - {V}_{n + 1}} .\end{matrix}$$

7. The positioning method of claim 2, wherein the relative extreme voltage is a minimum voltage when the first voltage is higher than the second voltage.

8. The positioning method of claim 7, wherein the coordinate Xt of the touch point satisfies an equation when V1 is the minimum voltage:
$$Xt = X 1 + {P}_{x} - {P}_{x} \times \frac{{V}_{1} - {V}_{2}}{{V}_{1} - {V}_{R}} ,$$
Y_{R} is a reference voltage, where V_{R}>V₂>V₁.

9. The positioning method of claim 7, wherein the coordinate Xt of the touch point satisfies an equation when Vₓ is the minimum voltage:
$$Xt = X x - {P}_{x} + {P}_{x} \times \frac{{V}_{x} - {V}_{x - 1}}{{V}_{x} - {V}_{R}} ,$$
Y_{R} is a reference voltage, where V_{R}>Vₓ₋₁>Vₓ.

10. The positioning method of claim 7, wherein the coordinate Xt of the touch point satisfies a set of equations when Vₙ is the minimum voltage and 2<n<x−1:
$$\{ \begin{matrix}{V}_{n - 1} < {V}_{n + 1} ⇒ Xt = Xn + {P}_{x} \times \frac{{V}_{n - 1} - {V}_{n + 1}}{{V}_{n} - {V}_{n - 1}} \\ {V}_{n - 1} = {V}_{n + 1} ⇒ Xt = Xn \\ {V}_{n - 1} > {V}_{n + 1} ⇒ Xt = Xn + {P}_{x} \times \frac{{V}_{n - 1} - {V}_{n + 1}}{{V}_{n - 1} - {V}_{n}} .\end{matrix}$$

11. The positioning method of claim 1, wherein the conductive layer is a carbon nanotube film.

12. The positioning method of claim 1, wherein the touch screen has a first electrode at a side of the touch screen opposite to the detecting electrodes, and the first voltage is provided to the conductive layer through the first electrode.

13. The positioning method of claim 12, wherein the extended direction of the first electrode and the arrangement direction of the detecting electrodes are perpendicular to a main conducting direction of the conductive layer.

14. The positioning method of claim 12, wherein the first voltage is provided to the non-measured detecting electrodes when the detecting electrodes are sequentially measured.

15. A positioning method for a touch screen, comprising:
providing the touch screen comprising a first conductive layer, a plurality of separated first detecting electrodes disposed at a side of the touch screen, a second conductive layer, and a plurality of separated second detecting electrodes disposed at another side of the touch screen perpendicular to the first detecting electrodes, and each of the first conductive layer and the second conductive layer having anisotropic impedance;
providing a first voltage to the first conductive layer;
providing a second voltage to the second conductive layer wherein a contact between the first conductive layer and the second conductive layer is defined as a touch point;
measuring voltages of the first detecting electrodes, selecting the relative extreme voltage from the voltages of the first detecting electrodes and the voltage of the first detecting electrode closest to the relative extreme voltage from the voltages of the first detecting electrodes, and determining a horizontal coordinate of the touch point according to the relative extreme voltage from the voltages of the first detecting electrodes and the position of the first detecting electrode providing the voltage closest to the relative extreme voltage from the voltages of the first detecting electrodes; and
measuring voltages of the second detecting electrodes, selecting the relative extreme voltage from the voltages of the second detecting electrodes and the voltage of the second detecting electrode closest to the relative extreme voltage from the voltages of the second detecting electrodes, and determining a vertical coordinate of the touch point according to the relative extreme voltage from the voltages of the second detecting electrodes and the position of the second electrode providing the second voltage closest to the relative extreme voltage from the voltages of the second detecting electrodes.

16. The positioning method of claim 15, wherein the second detecting electrodes are defined as E₂₁ to E_{2y}, the voltages respectively corresponding to the second detecting electrodes E₂₁ to E_{2y} are defined as V₁′ to V_{y}′, coordinates of the second detecting electrodes are defined as Y₁ to Y_{y}, a distance between any adjacent two of the second detecting electrodes is defined as 2Py, Vₘ′ is the relative extreme voltage from the voltages of the second detecting electrodes, the second detecting electrode providing the relative extreme voltage is defined as E₂ₘ, 2≦m≦y−1, the two second detecting electrodes closest to the second detecting electrode providing the relative extreme voltage are defined as E₂ₘ₋₁ and E₂ₘ₊₁, and the coordinate of the touch point in the arrangement direction of the second detecting electrodes is Yt.

17. The positioning method of claim 16, wherein the relative extreme voltage from the voltages of the first detecting electrodes is a maximum voltage and the relative extreme voltage from the voltages of the second detecting electrodes is a minimum voltage when the first voltage is lower than the second voltage.

18. The positioning method of claim 17, wherein the coordinate Yt of the touch point satisfies an equation when V₁′ is the minimum voltage:
$$Yt = Y 1 + {P}_{y} - {P}_{y} \times \frac{{V}_{1}^{′} - {V}_{2}^{′}}{{V}_{1}^{′} - {V}_{R}^{′}} ,$$
V_{R}′ is a reference voltage, where V_{R}′>V₂′>V₁′.

19. The positioning method of claim 17, wherein the coordinate Yt of the touch point satisfies an equation when V_{y}′ is the minimum voltage:
$$Yt = Yy + {P}_{y} - {P}_{y} \times \frac{{V}_{y}^{′} - {V}_{y - 1}^{′}}{{V}_{y}^{′} - {V}_{R}^{′}} ,$$
V_{R}′ is a reference voltage, where V_{R}′>V_{y-1}′>V_{y}′.

20. The positioning method of claim 17, wherein the coordinate Yt of the touch point satisfies a set of equations when Vₘ′ is the minimum voltage and 2<m<y−1:
$$\{ \begin{matrix}{V}_{m - 1}^{′} < {V}_{m + 1}^{′} ⇒ Yt = Ym + {P}_{y} \times \frac{{V}_{m + 1}^{′} - {V}_{m - 1}^{′}}{{V}_{m}^{′} - {V}_{m + 1}^{′}} \\ {V}_{m - 1}^{′} = {V}_{m + 1}^{′} ⇒ Yt = Ym \\ {V}_{m - 1}^{′} > {V}_{m + 1}^{′} ⇒ Yt = Ym + {P}_{y} \times \frac{{V}_{m + 1}^{′} - {V}_{m - 1}^{′}}{{V}_{m}^{′} - {V}_{m - 1}^{′}} .\end{matrix}$$

21. The positioning method of claim 16, wherein:
the relative extreme voltage from the voltages of the first detecting electrodes is a minimum voltage and the relative extreme voltage from the voltages of the second detecting electrodes is a maximum voltage when the first voltage is higher than the second voltage.

22. The positioning method of claim 21, wherein the coordinate Yt of the touch point satisfies an equation when V₁′ is the maximum voltage:
$$Yt = Y 1 + {P}_{y} - {P}_{y} \times \frac{{V}_{1}^{′} - {V}_{2}^{′}}{{V}_{1}^{′} - {V}_{R}^{′}} ,$$
V_{R}′ is a reference voltage, where V₁′>V₂′>V_{R}′.

23. The positioning method of claim 21, wherein the coordinate Yt of the touch point satisfies an equation when V_{y}′ is the maximum voltage:
$$Yt = Yy - {P}_{y} + {P}_{y} \times \frac{{V}_{y}^{′} - {V}_{y - 1}^{′}}{{V}_{Y}^{′} - {V}_{R}^{′}} ,$$
V_{R}′ is a reference voltage, where V_{y}′>V_{y-1}′>V_{R}′.

24. The positioning method of claim 21, wherein the coordinate Yt of the touch point satisfies a set of equations when Vₘ′ is the maximum voltage and 2<m<y−1:
$$\{ \begin{matrix}{V}_{m - 1}^{′} < {V}_{m + 1}^{′} ⇒ Yt = Ym + {P}_{y} \times \frac{{V}_{m + 1}^{′} - {V}_{m - 1}^{′}}{{V}_{m}^{′} - {V}_{m - 1}^{′}} \\ {V}_{m - 1}^{′} = {V}_{m + 1}^{′} ⇒ Yt = Ym \\ {V}_{m - 1}^{′} > {V}_{m + 1}^{′} ⇒ Yt = Ym + {P}_{y} \times \frac{{V}_{m + 1}^{′} - {V}_{m - 1}^{′}}{{V}_{m}^{′} - {V}_{m + 1}^{′}} .\end{matrix}$$

25. The positioning method of claim 15, wherein the first conductive layer and the second conductive layer are carbon nanotube films, and main conductive directions of the first conductive layer and the second conductive layer are perpendicular to each other.

26. The positioning method of claim 15, wherein a first electrode is disposed at a side of the first conductive layer opposite to the first detecting electrodes, the first voltage is provided to the first conductive layer through the first electrode, a second electrode is disposed at a side of the second conductive layer opposite to the second detecting electrodes, and the second voltage is provided to the second conductive layer through the second electrode.

27. The positioning method of claim 26, wherein the extended direction of the first electrode and the arrangement direction of the first detecting electrodes are perpendicular to a main conducting direction of the first conductive layer, and the extended direction of the second electrode and the arrangement direction of the second detecting electrodes are perpendicular to a main conducting direction of the second conductive layer.

28. The positioning method of claim 26, wherein the first voltage is provided to the non-measured first detecting electrodes when the first detecting electrodes are sequentially measured.

29. The positioning method of claim 26, wherein the second voltage is provided to the non-measured second detecting electrodes when the second detecting electrodes are sequentially measured.
